(19) United States
(12) Patent Application Publication
(10) Pub. No.: US 2026/0151924 A1
(43) Pub. Date: Jun. 4, 2026

(54) KNIFE

(71) Applicant: MARTOR KG, Solingen (DE)

(72) Inventors: Martin ROHRBACH, Göggingen (DE); Oliver BRECHTEL, Eckental (DE); Martin HERLITZ, Remscheid (DE)

(21) Appl. No.: 19/350,343

(22) Filed: Oct. 6, 2025

(30) Foreign Application Priority Data
Oct. 8, 2024 (DE) 10 2024 128 908.2

(51) Int. Cl. B26B 1/04; B26B 5/00; B26B 29/02

(52) U.S. Cl. CPC B26B 1/04; B26B 5/00; B26B 29/02

(57) ABSTRACT

A knife with a holder with a handle region and with a cutting head on which a blade with a cutting edge is mounted, wherein the cutting edge can be supplied with cutting material via a cutting channel with a width, which cutting channel is bounded by a first wall surface and a second wall surface. At least one region of the first wall surface is associated with a movable protective element so that the cutting channel has a first width in the first position of the protective element and a second width in a second position, the second width being greater than the first width.

The invention relates to a knife.

Such a knife is known from prior use. It comprises a handle region and a cutting head on which a blade is held. A cutting edge of the blade is accessible via a cutting channel. The cutting channel is designed, for example, in such a way that parts of the user's body cannot come into contact with the cutting edge.

US 2010/0293796 A1 describes a knife in which a blade is movably mounted on a holder. The blade has retraction channels which are provided with a cutting edge. The blade is movable relative to the holder between a first position, in which a cutting operation can be performed, and a second position, in which the cutting edge is covered by the holder and a cutting operation is not possible.

The object of the invention was to create a knife with a cutting channel that limits access to the cutting edge but allows for other cutting applications and meets high safety requirements. Furthermore, the objective of the invention was to create a robust knife.

The object was achieved by a knife having the features of claim 1.

The knife according to the invention comprises a holder with a handle region and a cutting head on which a blade with a cutting edge is mounted. The knife can be held by the handle region. The blade protrudes beyond the cutting head. The cutting edge is only accessible via a cutting channel. The cutting channel is bounded by spaced-apart wall surfaces. In addition, the channel is bounded at one end by a portion of the blade. Cutting material can be fed to the cutting edge through the cutting channel formed between the wall surfaces.

At least one region of a first wall region is formed by a movable protective element. The protective element is movable in such a way that the cutting channel can be adjusted between a first width and a second width. The movement of the protective element can be a rotary, translatory, or mixed movement with rotary and translatory components.

The first width, which has a distance of 4 mm, for example, can be such that a GS test finger cannot be moved through the cutting channel to the cutting edge. This means that no body parts can come into contact with the cutting edge. Only cutting materials up to a certain thickness can be cut.

The second width is such that thicker materials can also be cut. Safety is lower in this position because it cannot be ruled out that narrow body parts could also be moved into the cutting channel. After cutting thick materials, the protective element can be manually or automatically returned to the first position so that a high level of safety is restored.

The knife according to the invention, with the protective element in the first position, generally ensures a high level of safety because access to the cutting edge is limited by a channel in such a way that parts of the user's body cannot pass through it. In the event that thicker materials are to be cut than is possible with a narrow cutting channel, the protective element can be moved to a second position for the duration of the cut, in which the cutting channel is wider. The knife therefore offers a wider range of applications. Since the widening of the cutting channel is actively performed by the user, they are aware of the increased danger and therefore carry out the work with the necessary caution. The knife is highly robust due to the blade, which can be attached to the holder in a detachable or non-detachable manner.

The protective element can be adjusted between a first position, in which the gap has a first width, and a second position, in which the gap has a second width, the second width being greater than the first width.

The protective element can be moved, for example, by means of a handle that is part of an actuating device. The handle can be designed in any suitable form. For example, the handle can be designed as a slider, a push button, or a lever. If the handle is designed as a slider, for example, the knife can be made very compact.

A handle in the form of a lever can, for example, be designed as a pliers actuator, whereby a first lever forms a pivot joint with a second lever so that the levers can pivot relative to each other. If the handle is in an inactive position, the protective element is, for example, arranged in the first position. When the handle is in an active position, the protective element is arranged in the second position, for example. Designing the handle as a lever can have ergonomic advantages, for example.

The protective element performs, for example, a translational and/or rotational movement when moving between the first position and the second position. A mechanism may be formed between the handle and the protective element. The movement of the handle differs, for example, from the movement of the protective element or, alternatively, corresponds to the movement of the protective element.

A motion converter is, for example, part of the actuating device and can, for example, convert the movement of the handle into a different movement of the protective element. For example, the handle has a translational movement which is converted into a rotational movement of the protective element by means of a motion converter. Alternatively, the movement of the handle could be rotational and move the protective element translatorially.

The handle can, for example, be connected to the protective element by a mechanism that is also part of the actuating device. When the handle is in an inactive position, the protective element is in the first position, and when the protective element is in the active position, the protective element is in the second position.

In principle, the protective element or the handle can be locked or latched in the first position and/or in the second position. In terms of safety, it is advantageous if the protective element automatically moves to the first position as soon as the actuating device of the handle is moved to the second position. In this case, the protective element cannot be locked in the second position, but can move freely back to the first position. According to one embodiment, it may also be possible to choose between locking in the second position and automatic reset.

The protective element is biased back to the first position, for example by means of return means. The return means comprise, for example, at least one spring. By the protective element being biased to the first position, the protective element automatically moves back from the second position to the first position when the actuating device is inactive, restoring the high level of safety. This prevents the reset from being missed, which could increase the risk of injury when the knife is used again.

The movement of the protective element from the first position to the second position can be blocked, for example, by means of a blocking element that can be moved between a blocking position and a pass position. This prevents a force acting on the protective element from unintentionally moving the protective element toward the second position and thus enlarging the cutting channel. With the locking element, the locking element is only moved into the pass position when the handle is deliberately actuated, so that the protective element can move. When moving between the blocking position and the pass position, the blocking element can perform a translational, rotational, or mixed movement with translational and rotational components. The movement of the blocking element can differ from the movement of the protective element, for example. In this case, unintentional actuation can occur, for example, due to inertial forces directed in a certain direction.

The blocking element is, for example, motion-coupled with the actuating device so that when the actuating device moves from the inactive position to the active position, it moves from the blocking position to the pass position. It moves, for example, in the same direction as the handle. Alternatively, it can also move in a different direction of movement with respect to the handle.

By means of a first range of movement of the handle, the blocking element can be moved, for example, from the blocking position to the pass position, and by means of a second range of movement, the protective element can be moved, for example, from the first position to the second position. If the blocking element is coupled to the handle, it has a lead, e.g., with respect to the actuating device of the protective element, so that the blocking element is moved into the pass position before the protective element is moved into the second position. When the handle is moved into the active position, the blocking element is then moved into the pass position first, for example, and then the protective element is moved from the first position into the second position. Once the protective element is in the pass position, it can also be moved passively into the second position. This has the advantage that the user does not have to hold the handle in the active position against the force of a return element, but only has to operate it to an intermediate position in which the locking element is in the pass position. These features help to prevent fatigue.

The handle is formed, for example, on the grip region. Simple and ergonomically advantageous operation is ensured when the handle is formed on the grip region. At least one handle can be arranged, for example, on one side or on opposite sides of the grip region. For example, a first handle is arranged on one side of the holder and a second handle is arranged on an opposite side. A housing-like grip region may, for example, have at least one window through which the handle is connected to the protective element. If there are several handles, the grip region may have several windows. The handle may perform a translational movement and/or a rotational movement to adjust the protective element between the first position and the second position.

A longitudinal axis of the cutting edge extends, for example, in a direction perpendicular to a longitudinal center axis of the knife handle. Alternatively, the longitudinal axis of the cutting edge extends, for example, at an obtuse angle to the longitudinal axis. The cutting edge is located, for example, on a side of the blade facing the knife handle. In other words, the cutting edge points, for example, toward a rear end of the holder. It is then possible to make a pulling cut with the knife.

The blade is generally held firmly or detachably to the knife head. If the blade is held firmly to the knife head, it can, for example, be injected into the holder or be permanently connected to the holder in another way.

For example, the blade is detachably mounted on the holder. For example, the blade can be locked in a blade seat by means of a blade lock comprising a latch. The blade seat is formed, for example, by a shaft or a form-fitting receptacle. The blade can then be locked in the blade seat with the latch.

The blade is mounted, for example, on a blade holder. A blade holder ensures easy assembly and disassembly of the blade. The blade holder can be a separate part or molded onto the holder. The blade holder has, for example, retaining means which hold the blade in a predetermined position. The blade can, for example, be firmly connected to the blade holder, e.g., by injection molding, or it can be detachably attached to the blade holder. In the latter case, the blade holder is reusable.

The latch is designed to be movable between a locked position and a released position, for example. In this case, there are defined positions for blade replacement and for cutting work. This ensures a high level of safety in both states of the knife. In the locked position, the first locking means and the second locking means are engaged, and in the released position they are disengaged.

The blade lock comprises, for example, first locking means associated with the lock and second locking means associated with the blade. The interacting locking means are formed, for example, by form-fitting means or force-fitting means, such as a projection and a recess. The second locking means are formed, for example, directly on the blade or on a part connected to the blade. For example, a region of the blade is overmolded with plastic. The second locking means are formed, for example, in the overmolded region.

The bolt is formed, for example, as a lever. In the locking position, it can be inserted into a recess in the holder in such a way that it does not impair either the cutting work or the ergonomics of the handle region. For example, the holder has a recess in which the latch is accommodated in the locking position so that it does not protrude beyond the outer contour of the holder, or only insignificantly. The latch can be moved between the locking position and the release position when it is designed as a lever.

One region of the blade is provided with a guard, for example, which forms a gripping surface. The blade can then be safely gripped at the gripping surface without risk of injury and, for example, removed from or inserted into a blade seat. The guard is made of plastic, for example. The blade is overmolded with plastic, for example.

For example, the second locking means are formed on the protective cover. In this way, the second locking means can be shaped independently of the blade. This improves the possibilities for the arrangement and design of the second locking means.

The bolt has, for example, a locking element and the holder has a counter lock, whereby the locking element and the counter lock can be detachably engaged in the locking position. These features prevent the bolt from moving unintentionally and ensure that the blade lock is not unintentionally moved to the release position. The locking can be released, for example, by overcoming a threshold force on the bolt. Alternatively, the bolt could also be locked in the locked position. In this case, instead of the locking elements, the holder and the bolt would have bolt elements.

The holder and the protective element are made of plastic, for example. Alternatively, they could be made of metal, in particular cast metal, or of a composite material, in particular a composite plastic.

One wall surface of the cutting channel is formed, for example, by a bead which is molded onto an end region of the blade. The bead is made, for example, of plastic. A first side wall faces, for example, the handle region. A second side wall is opposite the first side wall in relation to the cutting edge. By forming the second side wall from a plastic bead, material can be saved in the cutting head, which would otherwise be formed between the cutting head and the bead. This reduces costs. Alternatively, the cutting head forms the first wall surface and the second wall surface, for example.

Examples of embodiments of the invention are described in the following description of the figures, also with reference to the drawings. For the sake of clarity, identical or comparable parts or elements or regions are designated with the same reference numerals, in some cases with the addition of lowercase letters, even if different embodiments are concerned.

Features that are only described in relation to one embodiment may also be provided in any other embodiment of the invention within the scope of the invention. Such modified embodiments are also covered by the invention, even if they are not shown in the drawings.

All disclosed features are essential to the invention. The disclosure of the application hereby also includes the full content of the cited publications and the described prior art devices, also for the purpose of including individual or multiple features of these documents in one or more claims of the present application.

The Figures show in:

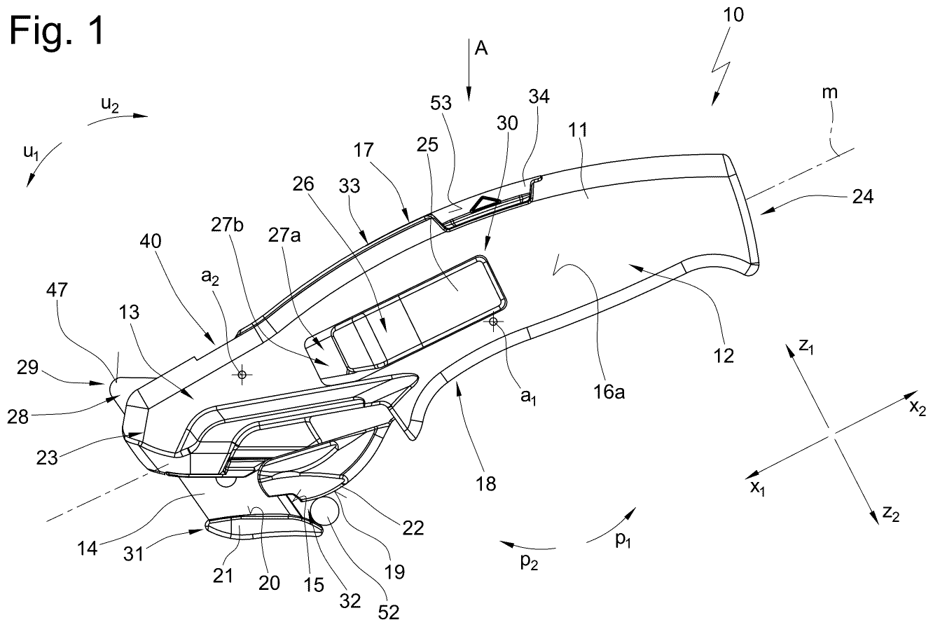

FIG. 1 a side view of the knife, with a protective element in the first position and the handle in an inactive position,

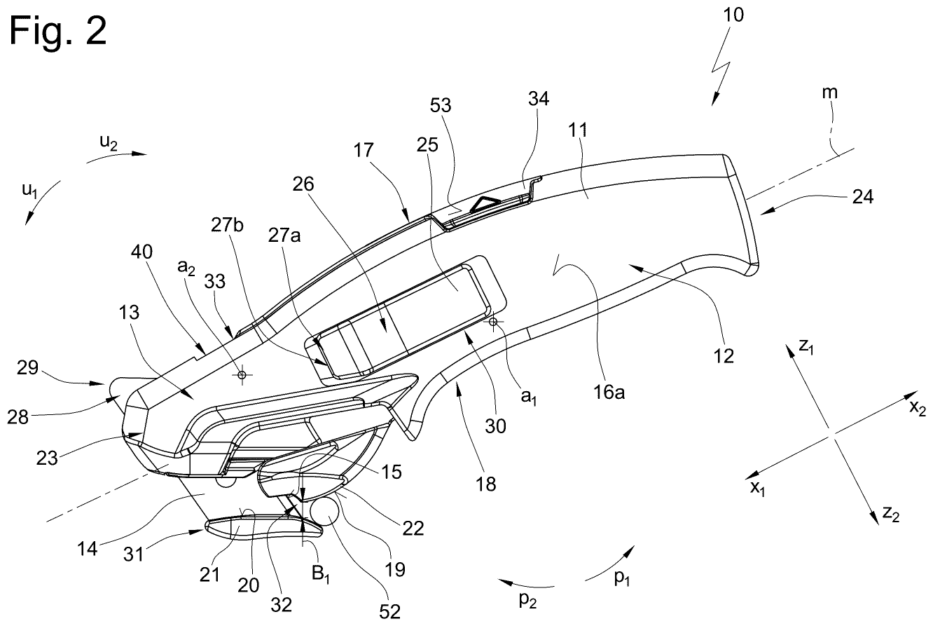

FIG. 2 shows a side view of the knife based on FIG. 1, with the handle moved to an intermediate position,

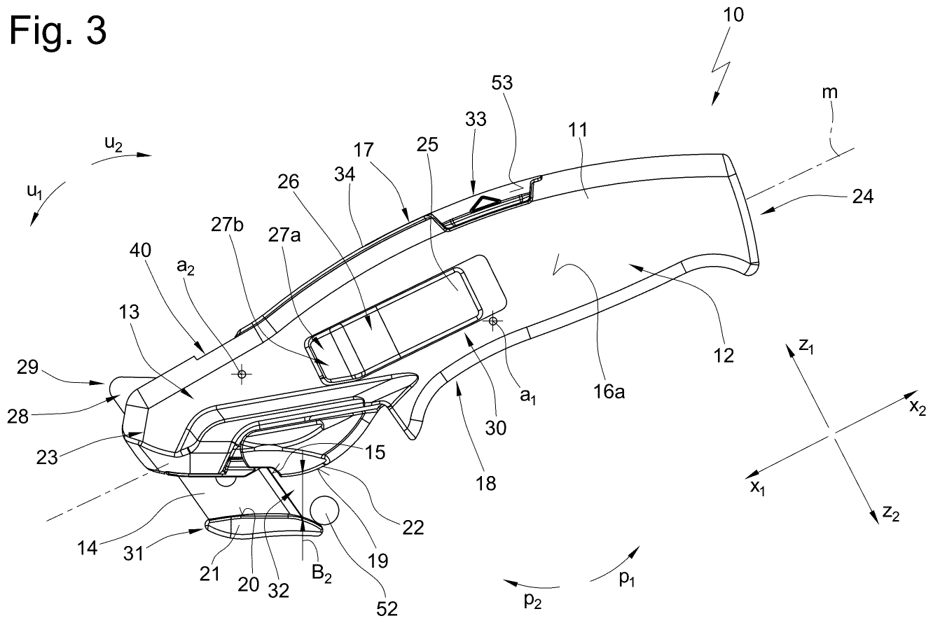

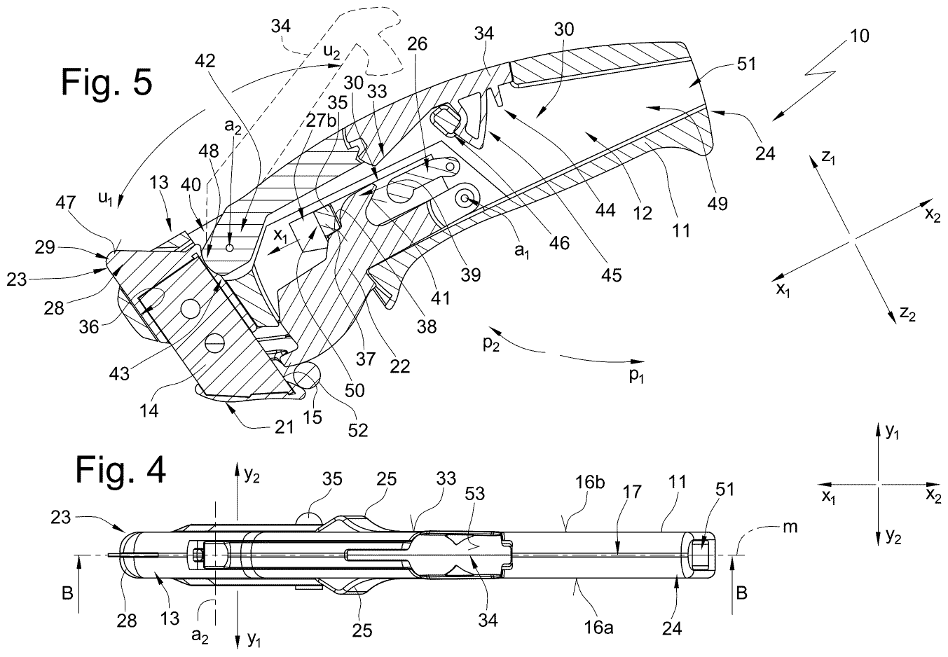

FIG. 3 is a side view based on FIG. 1, with the handle actuated to the active position and the protective element in the second position, FIG. 4 a view according to view arrow A in FIG. 1,

FIG. 5 a sectional view according to section line B-B in FIG. 4,

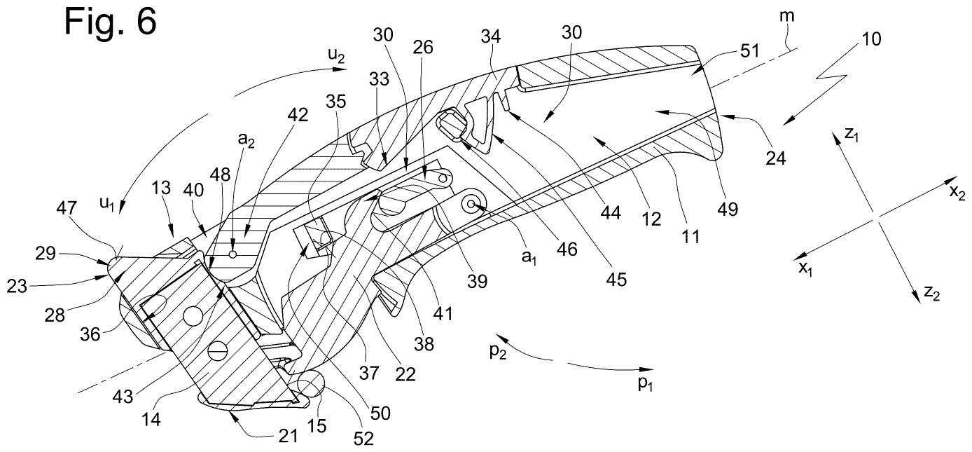

FIG. 6 a sectional view based on FIG. 5, with the handle in an intermediate position,

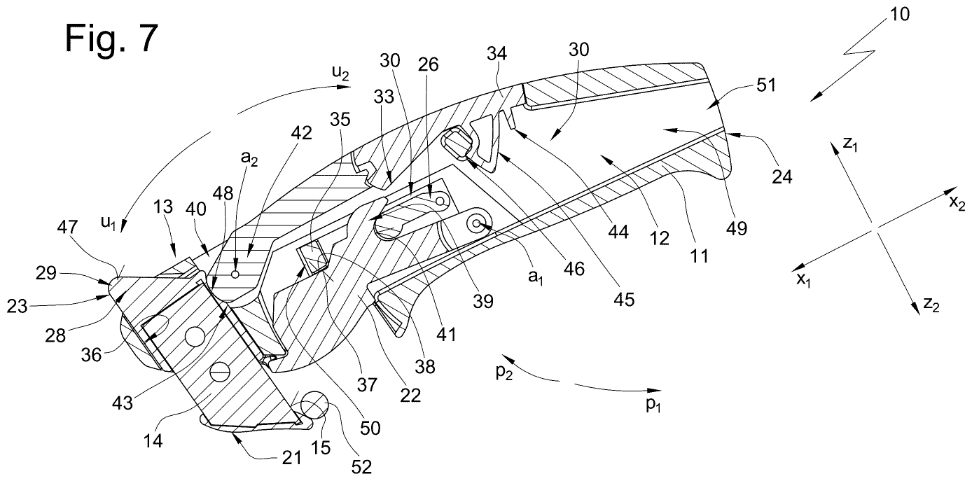

FIG. 7 a sectional view based on FIG. 6, with the handle in the active position and the protective element in the second position,

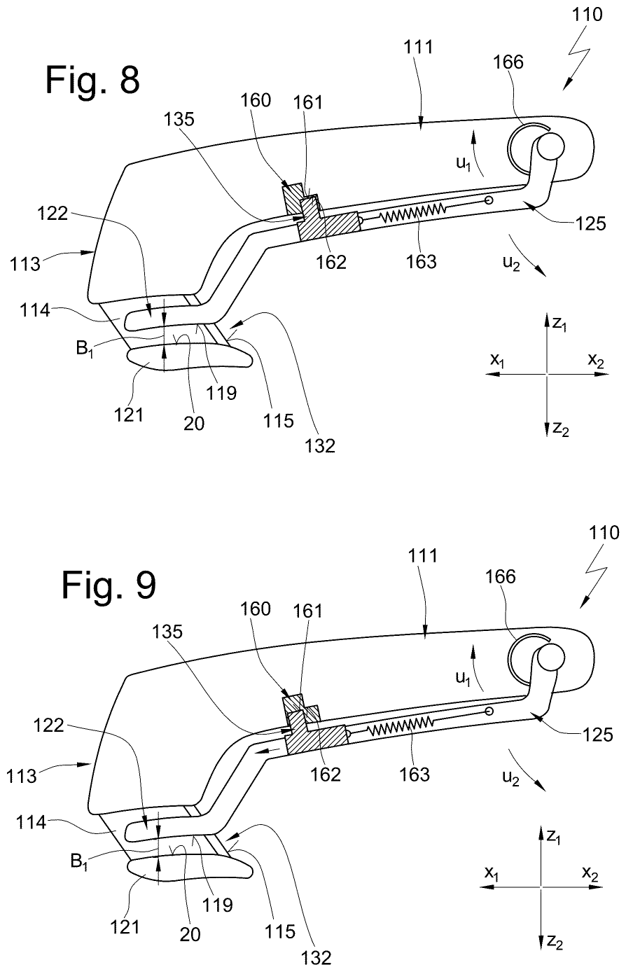

FIG. 8 a longitudinal sectional view of a second embodiment of the knife, wherein a protective element is in the first position and the handle is in an inactive position,

FIG. 9 is a sectional view according to FIG. 8, wherein the protective element is in the first position and the handle is in an intermediate position, and

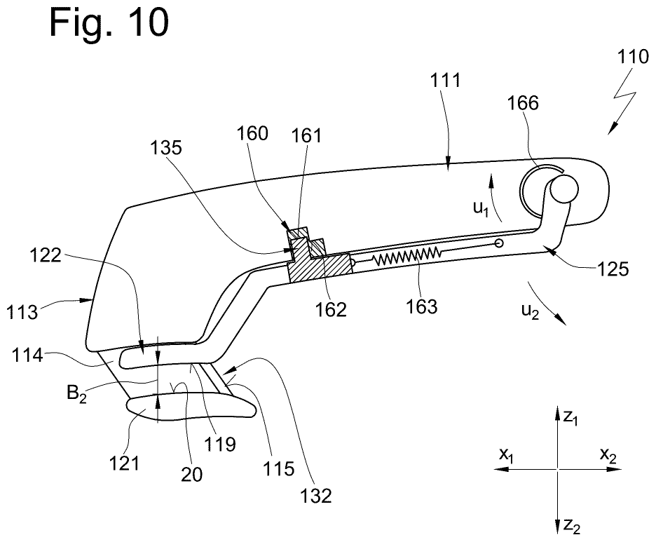

FIG. 10 is a sectional view according to FIG. 9, wherein the protective element is in the first position and the handle is in an active position.

The knife as a whole is designated by reference numeral 10 in the figures. FIG. 1 shows a side view of the knife 10. The knife comprises a holder 11 with a handle region 12 and a cutting head 13. The holder 11 comprises an upper end region 17, a lower end region 18, a front end region 23, and a rear end region 24. Side surfaces 16a and 16b extend between the upper end region 17 and the lower end region 18.

The cutting head 13, which comprises a blade 14, is formed on the front end portion 23 of the holder 11. A portion of the blade 14 is arranged in the holder 11 in a blade seat and is covered by the holder 11. Another part of the blade 14 protrudes from the holder 11 and extends, according to FIG. 1, in a direction z2 approximately perpendicular to a longitudinal center axis m of the holder 11. The blade 14 is mounted on the holder 11 so that it is immovable relative to the holder 11.

An end region 29 of the blade 14 is provided with a guard 28 which forms a gripping surface 47. When changing the blade, the blade 14 can be gripped by the guard 28 without any risk of injury from a cutting edge 15 of the blade 14. Another end region 31 of the blade 14 is provided with a bead 21 and forms a second wall surface 20 of a cutting channel 32 through which cutting material can be fed to a cutting edge 15 of the blade 14. In this example, the bead 21 is made of plastic and has been molded onto the blade 14. A first wall surface 19 of the cutting channel 32 is formed by a protective element 22.

It can be seen in FIG. 1 that the cutting edge 15 of the blade 14 is exposed between the wall surface 19 of the protective element 22 and the wall surface 20 of the bead 21. The width of the cutting channel 32 limits the dimensions of the cutting material fed to the cutting edge 15 and therefore also contributes to the safety of the knife 10. The greater the width of the cutting channel 32, the thicker the cutting material that can reach the cutting edge 15. According to FIGS. 1 and 2, the cutting channel has a width B1 which is dimensioned such that, based on average values, no part of a user's body can reach the cutting edge 15 through the cutting channel 32.

The cutting channel 32 of the knife 10 is designed to be variable in terms of the width of the cutting channel 32. It can be changed by moving the protective element 22. The protective element 22 can be adjusted between a first position shown in FIG. 1 and a second position shown in FIG. 3. In this example, the protective element 22 is mounted so that it can pivot about the pivot axis a1. In the first position, the cutting channel 32 has a width B1 and in the second position (see FIG. 3) a width B2. The width B1 is, for example, approximately 4 mm, and the width B2 is, for example, approximately 15 mm. These values for the widths B1 and B2 may alternatively be selected differently.

FIGS. 1 and 2 show a virtual test finger 52 with a diameter of 6 mm, which cannot pass through the cutting channel 32 and reach the cutting edge 15 in the first position. In the second position of the protective element 22 (see FIG. 3), thicker materials can be cut. The knife 10 has a lower safety status in the second position than in the first position. For this reason, the protective element 22 is loaded into the first position by a return element 22, e.g., a spring, which is not visible in FIG. 2. This means that the protective element 22 automatically returns to the first position.

The protective element 22 cannot be moved unintentionally into the second position. In other words, if a body part or a wide cutting material is forced into the cutting channel 32, the protective element 22 does not move out of the first position, i.e., it is not passively—i.e., unintentionally—moved from the first position to the second position. This is prevented by means that are explained further below.

According to FIG. 2, it can be seen that a handle 25 of an actuator 30 has been moved from the first position in the direction x1 to an intermediate position. Due to this first range of movement of the handle 25, a blocking element 35 (see FIGS. 5 to 7) of a safety device 50, which is not visible in FIG. 2, is moved out of the path of movement of an element of the actuator 30, so that the protective element 22 can be moved from the actuator 30 into the second position. In FIG. 6, which corresponds to the position of the actuator 30 according to FIG. 2, it can be seen that in the intermediate position of the handle 25, the safety device 50 is arranged in the pass position, so that the protective element 22 can move freely into the second position. The blocking element 35 has the function of preventing movement of the protective element 22 out of the first position in a blocking position and releasing movement of the protective element 22 in a pass position.

As soon as the blocking element 35 releases the protective element 22 in the pass position, the protective element 22 can be moved actively, i.e., by actuating the handle 25 in a second movement range into the active position, or passively, i.e., by applying a force to the protective element 22 (which is directed in such a way that it is moved into the second position), from the first position into the second position. Since the handle 25 is spring-loaded, less force is required for actuation.

FIG. 3 shows the knife 10 in the second position of the protective element 22. According to FIG. 3, the handle 25 is in the active position. The protective element 22 is moved into the second position against the restoring force of the restoring element. During the cutting process, the protective element 22 must be held in the active position according to FIG. 3 by actuating the handle 25 of the actuator 30 in order to prevent the protective element 22 from automatically moving from the second position to the first position. FIG. 3 shows that, at width B2 of the cutting channel 32, the test finger 52 is not prevented by the cutting channel 32 from reaching the cutting edge 15. Safety is therefore lower in the second position of the protective element 22 than in the first position.

As soon as the force on the handle 25 is released, the protective element 22 is returned from the second position to the first position and the handle 25 moves from the active position to the inactive position, in which the knife again has the highest level of safety. The automatic movement into the safe first position of the protective element, caused by the return element, is therefore possible at any time. In the process, the blocking element 35 is also automatically moved back from the pass position to the blocking position.

FIG. 4 shows a top view of the upper end 17 of the knife 10. A latch 34 is arranged in a recess 33 of the holder 11, which in this example can be pivoted about a pivot axis a 2 and is part of a blade lock 40. The blade 14 can be locked in the blade seat 36 with the latch 34, as described in more detail below. Both side surfaces 16a and 16b are visible.

The locking element 35 mentioned above (see FIG. 5) serves to prevent unintentional movement of the protective element 22 in the pivot direction p2 from the first position to the second position. A force applied to the protective element 35 in the direction p2 cannot unintentionally move it into the second position. The locking element 35 is shown in the locking position according to FIG. 5, while the handle 25 is in the inactive position according to FIG. 1.

An extension 39 of the protective element 22 is provided with an actuating surface 41. The actuating surface 41 interacts with the actuating element 26 of the actuating device, which is coupled to the handle 25 and, in this example, is fixedly connected to the handle 25 in terms of movement.

In the inactive position of the handle 25 (see FIGS. 1 and 5), an actuating element 26 connected to the handle 25 is arranged in the position shown, disengaged from the actuating surface 41 of the protective element 22. According to FIG. 5, a locking surface 37 of the blocking element 35 rests against a stop surface 38 of the protective element 22 and prevents the protective element 22 from moving in the direction p2 into the second position. The locking surface 37 can be moved out of the path of movement of the protective element 22 by moving the blocking element 35 in the direction x1 into the pass position.

In this example, the blocking element 35 is coupled to the handle 25. When the handle 25 is moved in the direction x1 into an intermediate position according to FIG. 6, the blocking element 35 is moved in the direction x1 from the blocking position into the pass position before the protective element 22 is moved. According to alternative embodiments, the blocking element 35 may, for example, be movable in a different direction of movement with respect to the movement of the handle 25. The type of movement (translational or rotational) may also differ from that of the handle 25.

It can be seen that, according to FIG. 5, the bolt 34 of a blade lock 40 is in a locking position. First locking means 48—in this example in the form of a projection of the front end region 42 of the bolt 34—engage with second locking means 43—here in the form of a recess in the guard 28—and thus lock the blade 14 in the blade seat 36. In the locked position, the latch 34 is located in the recess 33 of the holder 11 and thus does not protrude beyond the outer contour of the holder 11. By pivoting the latch 34 in the direction u1 into a release position (see dashed line in FIG. 5), the first locking means 48 are moved out of engagement with the second locking means 43. The blade 14 can then be removed from the blade seat 36.

It can be seen that the guard 28 forms the gripping surface 47 on which the blade 14 can be removed from or mounted in the blade seat 36. This prevents injury to the blade 14.

A locking element 45 is held at a rear end region 44 of the bolt 34, in this example molded onto the bolt 34, which, according to FIG. 5, is locked in engagement with a counter lock 46 of the holder 11. The locking element 45 is elastically deformable and can be disengaged from the counter detent 46 by exceeding a minimum force in the swivel direction u1.

The holder 11 is designed as a housing and has a receiving space 49 in which the bolt 34 and elements of the actuator 30, a section of the protective element 22, and a section of the blade 14 are accommodated. The receiving space 49 has windows 27a and 27b and an opening 51 at the rear end region 24. Dirt particles that have entered the receiving space can escape through the aforementioned openings and thus do not impair the knife function.

According to FIGS. 1 and 5, the handle 25 is inactive. The protective element 22 is arranged in the first position and the blocking element 35 is in the blocking position. When the handle 25 is moved to the intermediate position according to FIGS. 2 and 6, the blocking element 35 moves from the blocking position to the passing position shown in FIG. 6. When the handle 25 is moved further in the direction x1, the protective element 22 can now move because it is no longer blocked by the blocking element 35.

A comparison of FIGS. 5 and 6 shows that the actuating element 26 with the handle 25 has moved from the position shown in FIG. 5 in the direction x 1 into contact with an actuating surface 41 of the extension 39. The actuating surface 41 is designed in such a way that it deflects the force acting in the direction x1 on the handle 25 in such a way that a moment acts on the protective element 22 in the direction p1 about the axis of rotation a1, which swivels the protective element 22 in the direction p1 into the second position. In other words, the actuating surface 41 forms a motion converter with the actuating element 26. When the handle 25 is moved into the active position according to FIGS. 3 and 7, the protective element 22 moves into the second position (see FIG. 7).

As soon as the force on handle 25 is released, the protective element 22 is pivoted by the return element in the direction of p2, thereby moving the actuating element 26 and thus the handle 25 from the active position in the direction of x2 to the inactive position by means of the actuating surface 41. The handle 25 also moves the locking element 35 in the direction x2 from the pass position to the locking position.

To replace the blade 14, the end section 44 of the bolt 34 is pivoted in the direction u1 (see dashed line in FIG. 5), whereby the engagement of the locking element 45 is released from the counter lock 46 and the first locking means 48 and second locking means 43 move out of engagement. The blade 14 can then be removed from the blade seat 36 in the direction z1 and a new blade 14 can be inserted into the blade seat 36 in the direction z2. When the blade 14 is in the blade seat 36, the latch 34 can be pivoted in the direction u2 into the locking position, whereby the first locking means 48 and the second locking means 43 move back into engagement and the locking element 45 and the counter detent 46 move into engagement.

FIGS. 4 to 7 show that the bolt 34 is located in the recess 33 in the locking position. The bolt is recessed into the recess 33 in such a way that it protrudes only slightly from it. To actuate the bolt 34, an actuating surface 53 is pulled down onto the side surfaces 16a and 16b at the end region 44.

A second embodiment of the knife according to the invention is shown in FIGS. 8 to 10 and designated by reference numeral 110. The knife comprises a holder 111 () with a cutting head and a blade. The blade is detachable, e.g. in accordance with the first embodiment, or alternatively fixed to the holder 111. A handle 125 forms a pivot joint with the holder 111 at a first end region. The handle 125 is biased into the inactive position by a spring (not shown).

At a second end region, the handle 125 is provided with a protective element 122, which forms a first wall region 119 of the cutting channel 132. A second wall region is formed by a bead 121. In the first position of the protective element 122 according to FIG. 8, the cutting channel 132 has a width B1. The handle 125 is biased into the first position by a return element 166, in this case a spring not shown, as shown in FIG. 8.

A locking element 135 is movably mounted on the handle 125. It can be moved from a locking position according to FIG. 8 into a pass position according to FIGS. 9 and 10. The locking element 135 is loaded into the locking position by means of a spring 163. In the locking position, the locking element 135 interacts with a first structure 164. A stop surface 162 interacts with a counter surface 165 of the first structure 164 in such a way that the handle 125 cannot be moved from the first position into the second position. In the pass position, the locking element 135 can move past the counter surface 162 in such a way that the handle 125 can be moved actively or passively into the second position with the protective element 122 and the locking element 135 (see FIG. 10). In this embodiment, the locking element 135 engages with a second structure 160 of the holder 111.

1-19. (canceled)

20. A knife with a holder and a cutting head on which a blade with a cutting edge is mounted, wherein the cutting edge can be supplied with cutting material via a cutting channel with a width, which cutting channel is bounded by a first wall surface and a second wall surface, wherein at least one region of the first wall surface is associated with a movable protective element so that the cutting channel has a first width in the first position of the protective element and a second width in a second position, the second width being greater than the first width.

21. The knife according to claim 20, wherein the protective element is movable by an actuator comprising a handle.

22. The knife according to claim 20, wherein the handle is configured as a slider that is movable relative to the holder.

23. The knife according to claim 20, wherein the handle forms a pivot joint with the holder and is pivotable relative to the holder.

24. The knife according to claim 20, wherein the protective element is biased to the first position by return means.

25. The knife according to claim 21, wherein the movement of the protective element from the first position to the second position is blockable by a blocking element that is movable between a blocking position and a pass position.

26. The knife according to claim 25, wherein the blocking element is coupled to the actuator so that, when the actuator moves from the inactive position to the active position, the blocking element moves from the blocking position to the pass position.

27. The knife according to claim 25, wherein the locking element is movable from the locking position to the release position by first movement range of the handle, and the protective element is movable from the first position to the second position by a second movement range.

28. The knife according to claim 21, wherein the handle is formed on the holder.

29. The knife according to claim 20, wherein the cutting edge extends approximately at right angles or at an obtuse angle to a longitudinal center axis of the handle region.

30. The knife according to claim 20, wherein the blade is held firmly or detachably on the holder.

31. The knife according to claim 20, wherein the blade is lockable in a blade seat by a blade lock comprising a latch.

32. The knife according to claim 31, wherein the latch is movable between a locked position and a released position.

33. The knife according to claim 31, wherein the blade lock comprises first locking means associated with the latch and second locking means associated with the blade.

34. The knife according to claim 20, wherein the blade is associated with a guard that forms a gripping surface.

35. The knife according to claim 33, wherein the second locking means is formed on the guard.

36. The knife according to claim 31, wherein the latch is loackable in the locking position of the blade lock with a locking element of the latch and a counter lock of the holder.

37. The knife according to claim 20, wherein one of the wall surfaces is formed by a bead that is molded onto an end region of the blade.

38. The knife according to claim 20, wherein the protective element is loaded into the first position by a return element.
